(19) United States
(12) Patent Application Publication
(10) Pub. No.: US 2007/0027750 A1
(43) Pub. Date: Feb. 1, 2007

(54) Webpage advertisement mechanism

(75) Inventor: Peilin Chou, Taipei (TW)

Correspondence Address: BACON & THOMAS, PLLC, 625 SLATERS LANE, FOURTH FLOOR, ALEXANDRIA, VA, 22314, US

(73) Assignee: Bridgewell Inc., Taipei City (TW)

(21) Appl. No.: 11/190,979

(22) Filed: Jul. 28, 2005

(51) Int. Cl. G06Q 30/00

(52) U.S. Cl. 705/14

(57) ABSTRACT

The invented webpage advertisement mechanism comprises a database connecting module, a search condition input means, a database search module, an advertisement database, an advertisement search module and a display module. A search condition generator is provided to automatically generate search conditions for advertisements that are closely related to information of data files as results of another search, based on search conditions or search results of the other search. Advertisements with high relativity are displayed in web page showing results of data search at the same time to attract the attention of user who initiates the search.

### FIELD OF THE INVENTION

The present invention relates to a webpage advertisement mechanism, especially to a processing system that uses a data file analyzer to analyze content of webpage and to provide advertisement information in the webpage.

### BACKGROUND OF THE INVENTION

As the computer system and the internet are widely used in the recent years, searching for all kinds of useful information from a variety of large scale database systems through the internet has become an important park of everybody's daily life or work. Nowadays the computer system has integrated all kinds of useful information into huge databases. The internet further connects these databases into a even greater size database. Although this rapidly growing database provides a large quantity of documents and information, how to search desired information files in this world wide database has become an important technical task.

In order to solve this problem, there are many search engines being developed, allowing users to search desired documents in the internet. Such search engines in most cases provide their services to users in the form of website. When a user enters a search website, the user needs only to key-in so-called “keywords” and the search engine will search in databases connected with the internet data files with attributes or contents complying with or similar to the input keywords. Search results will then displayed in the webpage provided by the search engine website.

In the above-described conventional technology, there are two major approaches for searching data files. The most common way is called “keyword searching”, wherein content of documents contained in the searchable databases is compared with the input keywords and documents containing all the input keywords are considered “matched” files and are output as search results.

The second approach is to search data files using conditions including words that shall and shall not be contained in a desired document. In the search conditions, attributes of searching words may also be provided. The operation unit of the search engine uses logic operands such as “and” and “or” and whether a search words is contained in a document to calculate the relativity value of one document and the search conditions (called “Boolean Value”). The search results are documents with Boolean values greater than a threshold value.

U.S. patent application Ser. No. 11/036,428 discloses a portable database search agent processing system. The processing system provides the function of using a database search agent to search for related documents in a database.

After such a search, a substantial number of data files will be generated. These data files are complying with or highly complying with the search conditions. Most search engines would display a portion content of the searched data files, such their titles, in the webpage. In addition, most search service providers would open a window in the webpage displaying the search results to publish advertisements that are believed to be relative to the search results. This is because most search engines provide free search services to users and their major income comes from the advertisement. In theory, advertisements that users wish to see or that are attractive to users are those most relative to the topic of the search. As a result, how to calculate the relativity value of an advertisement and a search topic, has become a task for experts in this field.

U.S. Pat. No. 6,763,334 discloses a system and method to arrange delivery of advertisements in the internet. This invention provides a method for selecting suited advertising medium website according to conditions input by providers of advertisement, publishing advertisement in the media website, automatically generating advertising contracts and calculating advertise fees. Calculation of advertise fees includes calculating according to access count or click count. In this invention, a method for selecting suited advertising media website according to search conditions provided provider of advertisement is disclosed.

In addition, in the conventional art there is web page advertisement mechanism based on the structure of news website. Under said mechanism, advertisements are divided into classes according to classification of news reports and are displayed in the web page when news of the corresponding class is displayed therein.

### OBJECTIVES OF THE INVENTION

objective of this invention is to provide a control mechanism to dynamically select advertisements with content highly relative to content of data files that are represented by information displayed in a webpage.

Another objective of this invention is to provide a novel webpage advertisement mechanism that dynamically searches advertisements with greater relativities with displayed information on a webpage.

Another objective of this invention is to provide a new database search mechanism that uses results of prior search to search advertisements with high relativity but different attributes.

### SUMMARY OF THE INVENITON

According to the present invention, the webpage advertisement search mechanism comprises: a database connecting module, a search condition input means, a database search module, an advertisement database and a display module. In them:

The search condition comprises a user interface to allow user to input a group of or a plurality group of search conditions such that the database connecting module searches in a database, the internet and/or an advertisement database data files complying with the input search conditions;

The database connecting module is used to connect the website advertisement mechanism to a database, so to search related data files in the database; such database may be an independent digitalized database, an intranet or the internet;

The database search module is use to actuate the database connecting module to connect particular database and to search conditions obtained by the search condition input means to conduct searches in the database to generate search results; the search module may provide more than one search means;

The advertisement database is used to store a large quantity of advertisement data files, each advertisement data file being attached with an index file; the index file includes a plurality of parameters describing attributes of content of corresponding advertisements; The advertisement search means is used to search, according to a group of advertisement search conditions, in the advertisement database advertisement data files complying with or having high similarity with the search conditions and to generate search results; the advertisement search module may further a search condition generator to analyze content of one or more data file, including advertisement data file, to generate a group of advertisement search conditions;

The displaying module obtains from time to time search results generated by the database search module, obtains from the database data files represented by the search results through the database connecting module and displays on a display at lease a part of content of a portion of data files so obtained;

The displaying module also obtains from time to time from the advertisement database content of advertisement represented by the advertisement search results as generated by the advertisement search module and displays such content on the display;

Wherein, the advertisement search module may use the search condition generator to analyze content of at least one data file represented by results of a prior search after results of such prior search have been generated, to generate a group of advertisement search conditions and to actuate search of advertisement.

The above and other objectives and advantages of this invention may be clearly understood from the detailed description by referring to the following drawings.

### BRIEF DESCRIPTION OF THE DRAWINGS

FIG. 1 shows the systematic diagram of the webpage advertisement mechanism of this invention.

FIG. 2 shows a webpage wherein both descriptive content of searched data files and content of advertisement are shown simultaneously.

FIG. 3 shows the input interface for inputting attribute descriptive data of advertisements of this invention.

FIG. 4 shows the flow chart of the method used in the webpage advertisement mechanism of this invention.

### DETAILED DESCRIPTION OF THE INVENTION

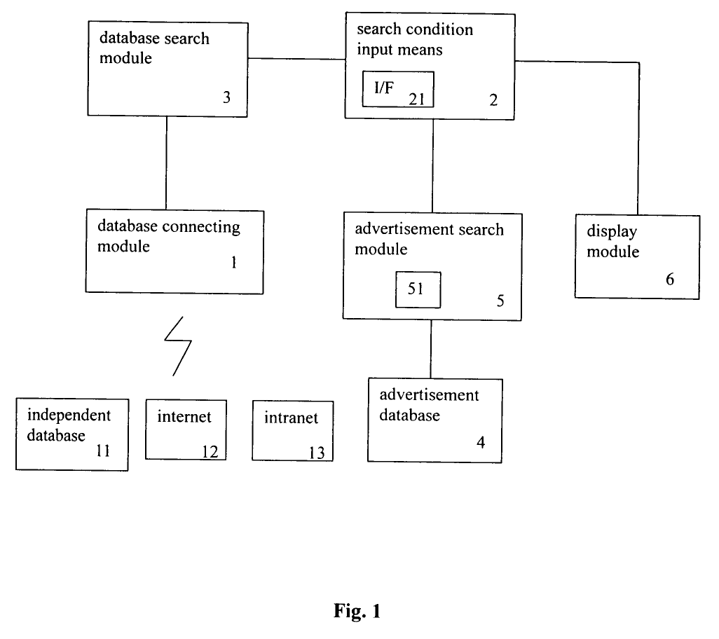

FIG. 1 shows the systematic diagram of the webpage advertisement mechanism of this invention. The webpage advertisement mechanism of this invention functions as a system to allow users to online or off-line search in a database for desired data files and to display content of advertisement at the same time. As shown in FIG. 1, the webpage advertisement mechanism of this invention comprises a database connecting module 1, a search condition input means 2, a database search module 3, an advertisement database 4, an advertisement search module 5 and a display module 6.

In the above-said elements, the search condition input means 2 comprises a user interface 21 to allow user to input one or more groups of search conditions, to be used in searching in a database 11, the internet 12 and/or an advertisement database 4 for desired data files. Generally speaking, such search condition input means may be provided in a webpage. An interactive interface may be used as the search condition input means 2, so that users may input search conditions into the page and observe displayed search results and advertisements generated according to content of such search results. Such search condition input means may be easily realized by those skilled in the art based on the known art. In addition, depending on number and types of search engine as provided, search conditions that the user may input include: keyword, logic operation rules of keywords, a short article, a long article, a descriptive file including a group of keywords (negative and positive) and their weight values, a graphic file, a motion picture, an audio file and any other conditions that may be used to search in databases.

The database connecting module 1 is used to connect the invented webpage advertisement mechanism to a database, in order to search related flies in the database. The database may be an independent digitalized database 11, the internet 12 or an intranet 13. Database connecting module 1 used in this invention includes any software or hardware tool that may connect with a database, search in that database and grab contents contained in the searched data files. As there are many commercially available database connecting tools in the market, including those written in Java, C++ or other programming language, those skilled in the art may readily develop software or hardware tools that may connect with large-size or small-size databases or databases connected to the internet, detailed description thereof is thus omitted.

The database search module 3 serves to actuate the database connecting module 1 to connect particular databases 11 and to search in the databases 11 according to search conditions obtained from the search condition input means 2, and to generate search results. The database search module 3 may provide more than one database search tools. In general, such database search module 3 may be a search engine. Depending on how a search engine is designed, the search engine may obtain content or indices of content of a data file in a database after it is connected to the database and compare the content or the indices with a group of search conditions. Similarity value or difference value representing similarity between the data file and the group of search conditions is calculated and compared with a threshold value. Data files with similarity values or difference values greater than the threshold value are selected as results of search. Any commercially available search tool may be used in this database search module 3. It is also possible for those skilled in the art to develop a useful database search tool to serve identical or similar functions. U.S. patent application Ser. No. 11/036,483 “Database Search System” disclosed a database search system that used a plurality of search engines to simultaneously or sequentially search data files according to their respective search rules. Such technology may be taken for reference in this invention.

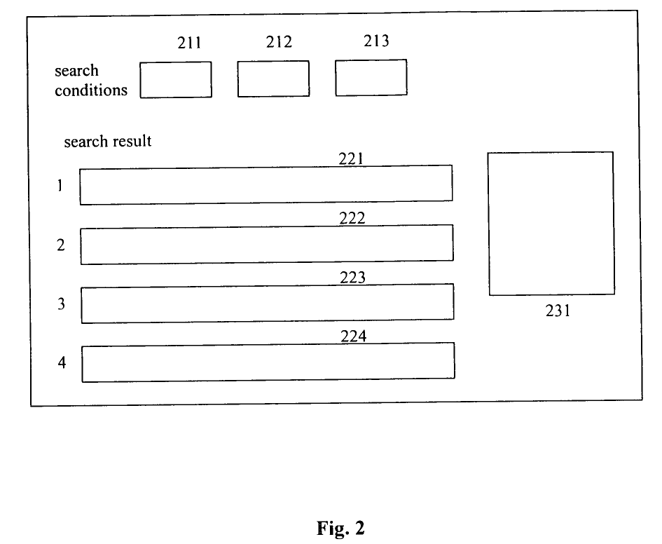

The advertisement database 4 is used to store a large quantity of advertisement data files. Each advertisement data file is attached with an index file, which includes a plurality of parameters describing attributes of the advertisement data file. When this invention is put to commercial applications, the advertisement database 4 is used to store a quantity of digital files of contracted advertisements to be published in or broadcast to web pages shown in user computer. When the system generates a “publish” or “broadcast” signal, selected advertisement files are obtained from the advertisement database and transmitted to designated accepters. In one embodiment of this invention, the advertisements are displayed in or broadcast to advertisement windows of web pages displaying content of data files as searched by the database search module 3. FIG. 2 shows a webpage wherein both descriptive content of searched data files and content of advertisement are shown simultaneously. In this figure, 211-213 are search condition bar, 221-224 are search result displaying sections, 225 represents a pseudo button allowing user to click in order to display more search results, and 231 represents advertisement displaying window.

As a general case, information contained in an advertisement file is in digital format. However, to analyze the attributes or features of the advertisement, such information is not sufficient. Especially when the content of the advertisement and the products or service promoted by the advertisement are totally irrelevant, it is impossible to use existing technology to analyze the attributes or features of the advertisement based directly on its content. In the embodiment of this invention, each advertisement file is given an attribute or feature descriptive file to define the attributes or features of the advertisement. Format of such descriptive file may be determined according to the specification of supporting search engine(s). However, an index file containing a plurality of “keywords” or “descriptive terms” or additionally their respective weight values may support most search engines. Of course, descriptive files of other formats may also be used in this invention, as long as the search engine may use these files to compare with particular search conditions and to calculate similarity value or difference value.

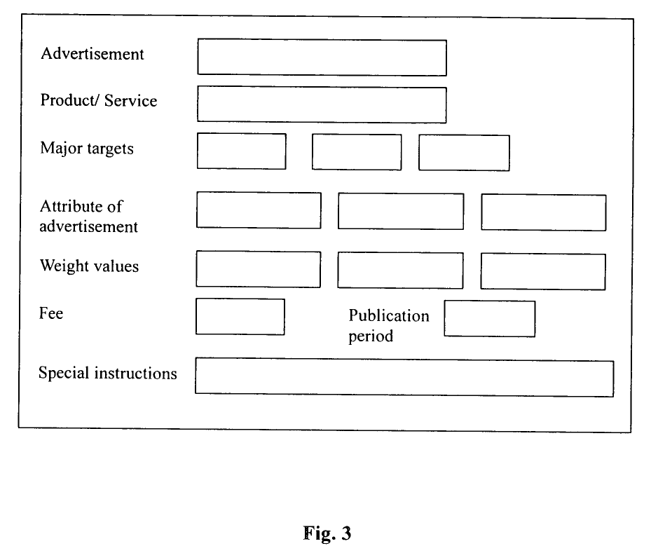

FIG. 3 shows the input interface for inputting attribute descriptive data of advertisements of this invention. In application, it is possible to provide an input tool in the user interface 21, so that the user may input descriptions of an advertisement, when the data file of the advertisement is input into the advertisement database. Such method and tool may be easily realized by those skilled in the art. Descriptions thereof are thus omitted. The method as described in the above said U.S. Pat. No. 6,763,334 may also be taken for reference.

The advertisement search means 5 searches in the advertisement database 4 for matched advertisements or advertisements with relative high similarity values according to a group of advertisement search conditions and generates search results. The advertisement search means 5 may include a search condition generator 51 to analyze content of one or more data files (including advertisement files) to generate a group of advertisement search conditions. In general, the structure of the advertisement search means 5 is similar to the database search module 3. The major difference between them is that the advertisement search means 5 searches data files in the advertisement database 4, while the database search module 3 searches in a broader field.

The search condition generator 51 is one of the important features of this invention. In the embodiment of this invention, the search condition generator 51 analyzes content of data files represented by search results generated by the database search module 3, to obtain a group of descriptions indicating attributes or features of the searched data files. Search condition generators that are applicable in this invention include those commercially available data analyzing software. U.S. patent application Ser. No. 10/794,698 discloses automatically analyzing content of a paragraph or the whole article to generate a group of descriptive indices representing attributes or features of the analyzed article. Such technology may be taken for reference in this invention.

In the embodiment of this invention, the search condition generator 51 may analyze content of a certain number of data files, such as data files with higher similarity values, after search results are generated by the database search module 3, and generate a descriptive index file to serve as search conditions for advertisements. In general applications, simply analyzing a portion content of the data file of highest similarity value may generate sufficient search conditions. Nevertheless, if descriptive files for attributes or features are already contained in resulted data files after search by the database search module 3, such attributes or features may be used as search conditions for advertisements directly. In other embodiments of this invention, analysis is conducted on descriptive indices attached to the searched data files to obtain a group of newly generated descriptive indices to serve as search conditions. In addition, it is also possible to use the group of search conditions which the database search means used to search as search conditions for advertisements.

In the present invention, when the user inputs a group of database search conditions in the input means 1, the database connecting module 2 connects particular databases and the database search module 3 searches in the databases to generate search results. The advertisement search means 5 simultaneously or later searches in the advertisement database 4 to generate search results.

In order to allow the user to monitor the searching activities, the display module 6 obtains from time to time search results generated by the database search module 3 and, based on the search results, obtain content of the resulted data files, so to display at least a portion content of selected number of resulted data files in the display 61. At the same time, the display module 6 also obtains from time to time from the advertisement database 4 content of resulted advertisements after searches of the advertisement search module 5 and displays content of the searched advertisements in the display device 61. As a result, when the user conducts a search, the webpage displaying the search result does not only show information of the resulted data files but also content of the resulted advertisement. Since search conditions for advertisements were generated according to attributes or features of the data files of the search results, advertisements displayed in the web page will be highly related to attributes or features of the resulted data files, which represent objectives of search as conducted. Such high relativity ensures the user's interest in reading content of the displayed advertisements and, even, in online purchasing products/services promoted by the displayed advertisements. Effects of advertisement are thus enhanced.

In commercial applications, when the web page shows the search results, only one advertisement will be shown. Therefore, it is highly recommended that only the advertisement that is most related to objectives of the search shall be displayed. Using a relativity or similarity calculating technology to calculate the relativity value or similarity value of a group of search conditions and content indicated by the descriptive index file of attributes or features of candidate advertisements, the relativity or similarity between the resulted data files and the candidate advertisements may be determined. In the example of FIG. 3, the index file Ai of an advertisement may be expressed as:
Aᵢ=I_{A1}W_{A1}+A2×W_{A2}+ . . . +Z_{An}×W_{An}
And a group of search conditions Cj may be expressed as:
Cⱼ=I_{C1}×W_{C1}+I_{C2}×W_{C2}+ . . . +I_{Cm}×W_{Cm}
The following formula may be used to calculate the relativity value or similarity value of the index file Ai and the search conditions Cj, as follows:

$$S = {\sum }_{1}^{n , m} {W}_{Ai} \times {W}_{Cj} ∀ {I}_{Ai} = {I}_{Cj}$$

wherein I represents attribute descriptions and W is their corresponding weight values. The weight values may be positive or negative. In selecting the most related advertisement, the advertisement with highest similarity value S may be chosen. Of course, in some circumstances, selecting the advertisement with the lowest negative value as most related advertisement might generate surprising but effective results. This is because in searching advertisements information provided in the descriptive file of attributes is limited and consumers of particular products or services may be users who search for data files of totally irrelevant topics.

For example, when a user is searching market information of PDA, web page advertisement system would tend to display advertisements of PDA products to attract the user. However, an advertisement of “Cruise in Caribbean”, although of a totally different topic, may attract the user to click on it, since the user may search for PDA in the preparation of an overseas trip.

Besides displaying advertisement with highest similarity value in the webpage that shows results of database search, it is also possible to periodically replace the displayed advertisement with other highly related advertisements in a particular sequence or randomly. In addition, it is also possible to dynamically analyze content of displayed information in blocks of the website where the user clicks or where the mouse indicates, to generate new advertisement search conditions, so that similarity values of the advertisements will be calculated and a new advertisement is selected and displayed in the web page.

According to the web page advertisement mechanism the relativity between advertisements and the objectives of a search may be calculated in the mean time when relativity between data files in the database and the objective of the search is calculated. Advertisement to be displayed in the web page may be selected immediately whenever the search results are displayed. It is also possible to provide a design wherein when user selects an area of the webpage, in which words or other information is displayed, the search condition generator 51 is actuated to simultaneously generate advertisement search conditions, such that advertisements related to the selected information may be displayed in the web page. In other words, as long as the selected area provides sufficient information to generate advertisement search conditions, search of advertisements may be conducted at any time, not only when the user is searching in the database.

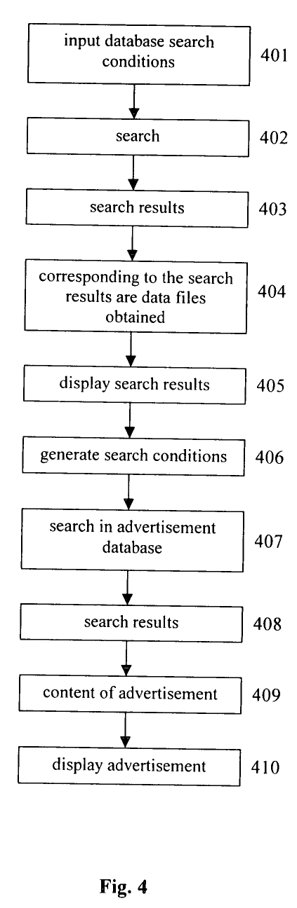

As described above, the web page advertisement mechanism of this invention processes a request of database search and displays related advertisements following the steps as shown in FIG. 4. FIG. 4 shows the flowchart of the method used in the web page advertisement mechanism of this invention. As shown in this figure, when advertising in a web page, at 401 the user inputs a group of database search conditions. At 402 search is conducted in a database according to the input search conditions and, at 403, search results are generated. At 404 data files corresponding to the search results are obtained and displayed in the web page at 405. At 406 a group of advertisement search conditions are generated according to content of data files corresponding to the search results. At 407, search is conducted in the advertisement database, whereby search results are generated at 408. At 409 content of advertisement corresponding to the search result of 408 is obtained and at 410 is display in the advertisement window of the website.

In the above-said steps, the advertisement search conditions may be search conditions as input by the user. They may also be a group of information displayed in the web page. The advertisement may be displayed in the web page in a window or in a plurality of windows, or a plurality of advertisements displayed in particular sequence or randomly.

In another embodiment of this invention, the relativity between an advertisement and a group of search condition may be modified using an adjustment means, so that new search conditions will be generated according to result of such modification, whereby even more correctly related advertisement may be searched. For example, when an advertisement was determined highly relative to particular data file but was seldom or never read or selected by users who have read content of that particular data file and number of such users exceeds a certain threshold, such as over 1,000 page views, the advertisement may be considered irrelevant to that particular data file. Under such condition, the advertisement search condition generator 51 may use the advertisement as “search agent”. In other words, the advertisement may be deemed a negative example to the group of search conditions. On the other hand, when one advertisement is selected by users when page view of a particular data file counts to a certain number, such as 1,000 page views, the advertisement may be deemed highly related to that data file. Such advertisement may be used as positive example of the group of search conditions. According to these negative and positive data files, the search condition generator 51 may modify the search conditions and generate a new group of search conditions. With the modified search conditions, it is possible to search in the database 11 to allocate most related data file and to display the advertisement in the webpage that displays the allocated data file. Such modification may be repeatedly conducted. The search condition generator 51 may also periodically scan all displayed articles in the web page, so to display or broadcast more proper advertisements in the web page. Higher relativities between searched data files and advertisements may thus be obtained.

Although search results varies from time to tome, the present invention is able to dynamically select most related advertisements according to current search results of the user. Such effect has never been provided by the conventional technology.

As the present invention has been shown and described with reference to preferred embodiments thereof, those skilled in the art will recognize that the above and other changes may be made therein without departing form the spirit and scope of the invention.

What is claimed is:

1. A web page advertisement mechanism, comprising a database connecting module, a search condition input means, a database search module, an advertisement database, an advertisement search module and a display module, wherein:
said search condition input means comprises a user interface to allow user to input one or more groups of search conditions, so that said database search module searches in a database, the internet and/or said advertisement database for data files according to said input search conditions;
said database connecting module connects said web page advertisement mechanism to particular database in order to search data files according to said search conditions;
said database search module is used to actuate said database connecting module to connect particular database and to search in said particular database according to search conditions obtained from said search condition input means to generate search results;
said advertisement database stores a quantity of advertisement files, each being attached with an index file to include a plurality of parameters describing attributes of content of said advertisement file;
said advertisement search means searches in said advertisement database according to a group of advertisement search conditions to generate search results; and
said display module obtains from time to time search results generated by said database search module, obtains from said database data files corresponding to said search results, and displays in a display device at least a portion content of selected number of said data files;
wherein said advertisement search module may, after search results of said database search module are generated, generate a group of advertisement search conditions according to content of at least one data file of the search results and actuates search of advertisements.

2. The web page advertisement according to claim 1, wherein said database comprises an independent digital database, an intranet or the internet.

3. The web page advertisement according to claim 1, wherein said search module provides more than one database search methods.

4. The web page advertisement according to claim 1, wherein said display module obtains from time to time from said advertisement database content of advertisement corresponding to search results generated by said advertisement search module.

5. The web page advertisement according to claim 1, wherein said advertisement search module further comprises a search condition generator to analyze one or more data files, including advertisement files, to generate a group of advertisement search conditions.

6. The web page advertisement according to claim 5, wherein said search condition generator analyzes certain number of data files of relatively higher similarity values among data files corresponding to search results of said database search module to generate a descriptive index file to be used as said advertisement search conditions.

7. The web page advertisement according to claim 5, wherein said search condition generator uses descriptive files for attributes or features as attached to data files corresponding to search results of said database search module to be used as said advertisement search conditions.

8. The web page advertisement according to claim 7, wherein said search condition generator analyzes descriptive index files for attributes or features as attached to said plurality of data files to generate a group of descriptive index to be used as said advertisement search conditions.

9. The web page advertisement according to claim 5, wherein said search condition generator uses a group of search conditions used in a previous search by said database search module as said advertisement search conditions.

10. The web page advertisement according to claim 1, wherein said database search module searches in said database immediately after said group of database search conditions are input and said advertisement search module searches in said advertisement database at the same time or at a later time.

11. The web page advertisement according to claim 1, wherein said advertisement search module calculates value of similarity between a group of search conditions and content of descriptive index file of candidate advertisement and determines search results according to similarity values so obtained.

12. The web page advertisement according to claim 11, wherein said advertisement search module selects advertisement with highest similarity value as search result.

13. The web page advertisement according to claim 11, wherein said advertisement search module selects advertisement with lowest negative similarity value as search result.

14. The web page advertisement according to claim 1, wherein said display module replaces displaying advertisement with advertisements of similarity values greater than a threshold value, in particular sequence or randomly.

15. The web page advertisement according to claim 1, wherein said advertisement search module analyzes information contained in areas selected by user to generate new group of search conditions and recalculates similarity values of selected advertisements.

16. The web page advertisement according to claim 1, wherein said advertisement search module analyzes information contained in areas selected by user to generate new group of search conditions and search advertisements that comply with said search conditions.

17. The web page advertisement according to claim 1, further comprising a modification mechanism to calculate similarity values of selected advertisements when an advertisement has never been selected by user after having been displayed in a website for a predetermined number of times.

18. Method for determining advertisement to be displayed in a web page according to a group of database search conditions, comprising the steps of:
accepting input by user a group of database search conditions;
searching in a database according to said input search conditions to obtain data files complying with said search conditions;
displaying in a web page at least a portion content of part of said obtained data files;
automatically generating a group of advertisement search conditions according to content of said obtained data files;
searching in an advertisement database according to said advertisement search conditions to obtain advertisements complying with said advertisement search conditions; and
displaying in said web page content of said obtained advertisements;
wherein files in said advertisement database are attached with an index file to include a plurality of parameters describing attributes of said advertisements.

19. The method according to claim 1, wherein said database comprises an independent digital database, an intranet or the internet.

20. The method according to claim 1, wherein said advertisement search search module provides more than one database search methods.

21. The method according to claim 18, wherein said advertisement search conditions are generated by analyzing certain number of data files, including advertisement files.

22. The method according to claim 20, wherein said advertisement search conditions are generated by analyzing certain number of data files of relatively higher similarity values among data files corresponding to search results of said database search module.

23. The method according to claim 18, wherein said advertisement search conditions are indices generated by analyzing descriptive indices attached to a certain number of data files.

24. The method according to claim 18, wherein said advertisement search conditions generator analyzes descriptive index files for attributes or features as attached to said plurality of data files to generate a group of descriptive index to be used as said advertisement search conditions.

25. The method according to claim 18, wherein said advertisement search conditions are generated immediate after said group of database search conditions are input.

26. The method according to claim 18, wherein searching in said advertisement database comprising calculating value of similarity between a group of search conditions and content of descriptive index file of candidate advertisement and determines search results according to similarity values so obtained.

27. The method according to claim 26, wherein advertisement with highest similarity value is selected as search result.

28. The method according to claim 26, wherein advertisement with lowest negative similarity value is selected as search result.

29. The method according to claim 18, further comprising the step of replacing displaying advertisement with advertisements of similarity values greater than a threshold value, in particular sequence or randomly.

30. The method according to claim 18, further comprising a step of analyzing information contained in areas selected by user to generate new group of search conditions and recalculates similarity values of selected advertisements.

31. The method according to claim 18, further comprising the step of analyzing information contained in areas selected by user to generate new group of search conditions and search advertisements that comply with said search conditions.

32. The method according to claim 18, further comprising a step of calculating similarity values of selected advertisements when an advertisement has never been selected by user after having been displayed in a website for a predetermined number of times.
